(19) United States
(12) Patent Application Publication
(10) Pub. No.: US 2006/0224524 A1
(43) Pub. Date: Oct. 5, 2006

(54) Method and system for publication

(76) Inventors: Simon Keeble, Hobe Sound, FL (US); Mark Chequer, Walnut Creek, CA (US); Bob Johnson, Hudson (CA)

Correspondence Address: QUARLES & BRADY LLP, 411 E. WISCONSIN AVENUE, SUITE 2040, MILWAUKEE, WI, 53202-4497, US

(21) Appl. No.: 11/094,630

(22) Filed: Mar. 30, 2005

(51) Int. Cl. G06Q 99/00; H04L 9/00; H04K 1/00

(52) U.S. Cl. 705/69

(57) ABSTRACT

A method and system for publication is disclosed wherein a publication service provider offers a publication service to a sponsoring organisation for publication of independent and sponsor-specific dependent information to targeted stakeholders in the sponsoring organisation's field of endeavour or industry. The publication system and method may be implemented on the Web such that opt-in stakeholders gain access to the publications through a sponsored Website and/or through e-mail communications. In general, the publications will be prepared by the service provider, who also provides the independent information therefore, in accordance with a customized layout and/or skin established cooperatively with the sponsor to reflect the visual signature thereof. The sponsoring organisation, provided with optional and customizable readership statistics from the service provider, may assess the reach and efficiency of the publication service therefrom and reconfigure its participation in the system when needed.

### FIELD OF THE INVENTION

The present invention relates to method and system for publication. In particular, the present invention relates to a web based method and system for custom publishing both independent and sponsored dependent information to a set of interested stakeholders in a company or industry.

### BACKGROUND OF THE INVENTION

Various publication services and information distribution methods have been devised to help various organisations provide information to their respective stakeholders and to stakeholders in their respective industries or fields of endeavour.

Note that in the above, and in the following disclosure, organisation is to be interpreted as, but not limited to, any company, corporation, firm, government, enterprise, institution, charity, sole trader, association, or parts or combination thereof and stakeholder is to be interpreted as any individual or group of individuals sharing a particular interest in an organisation, including for example, but not limited to, shareholders, employees, customers, clients, prospective partners, communities, suppliers, and the like.

Such methods and services include newsletters, promotional packages, published annual and periodic reports, corporate websites, newsgroups and Web communities, and the like. Other publication services, namely journals, magazines, independent websites and news sources, public newsgroups and Web communities, and the like, provide independent information to their subscribers and often allow sponsor-dependent advertisements and promotional materials provided by various sponsoring organisations to be included as a method for these organisations to potentially reach their respective stakeholders.

The information distribution methods and services listed above provide significant drawbacks, both for the sponsoring organisations and their respective stakeholders. For instance, when an organisation provides dependent information to stakeholders directly using a private publication medium, the information will necessarily appear as a promotional push that will inherently appear to lack transparency to the stakeholders. On the other hand, when publishing information through an independent news source, the information will be distributed to the independent news source's subscribers, and not to the stakeholders directly. Consequently, no feedback will be provided to the organisation concerning how effective the publication was at reaching their stakeholders, and of those reached, how many actually took notice of it. Furthermore, stakeholders interested in the published information may not have access to it, or even have no knowledge of its publication.

One particular subject of interest to stakeholders is information pertaining to an organisation's Corporate Social Responsibility (CSR) programs and activities. For instance, organisations may partake in a plurality of socially responsible programs to both help their community, whether local, national or international, and increase their reputational capital. Unfortunately, present press and publication means and methods don't necessarily allow for an effective distribution of information to interested stakeholders.

For instance, an organisation can promote its CSR program through an advertisement or article in a reputed magazine or journal. This publication is then delivered to the magazine's subscribers, who may or may not be stakeholders in the organization. Ultimately, some stakeholders may take notice of the publication, though many will not; the organisation will obtain no feedback to that effect. Furthermore, since the organisation paid to publish the information that was then delivered to all subscribers indiscriminately, stakeholders may not have sufficient information or means to establish the credibility of the publication.

In an alternative situation, the organisation will send out CSR reports and packages to their stakeholders. In this scenario, the information does reach only the selected stakeholders, but does not discriminate between those stakeholders that are interested in this type of publication, and those that are not. Furthermore, as the dependent information is again delivered directly by the publishing organisation, the reports may appear to stakeholders as simple public relations packages and no more than advertising. This factor strongly reduces the effect of CSR reports and provides little to no corporate advantage and return on investment (ROI) in CSR

In yet another alternative scenario, an external organisation may publish damaging information about an organisation that may be false, inaccurate, or simply overstated. In response, the organisation may chose to publish their side of the story to defend their actions. If this communication is done through a journal or magazine, most interested stakeholders may be kept in the dark and others will only be exposed to one side. This system is thus inefficient in providing stakeholders in the organisation the full accurate story, and at best, in an untimely manner.

Though the above examples discuss CSR publications and stakeholder interests therein, other publication types are distributed and effected in the same way. For example, stakeholders in the shipping industry may be interested in obtaining access to information about advances and conditions of the services of various shipping companies. Unfortunately, information is either provided to them directly as advertising, or debated without reference in various publication systems with which they may or may not be familiar.

A better publication system and method is thus needed to provide better access to specific information to targeted stakeholders interested in the activity of the organisation or industry within which they are stakeholders. The present invention, described herein and with reference to the appended illustrative drawings, provides a web-based publication system, method and service, and alternative embodiments thereof, that overcome the above and other drawbacks of standard publication methods and services.

### SUMMARY OF THE INVENTION

More specifically, in accordance with the present invention, there is provided a method for providing an electronic publication service, the service sponsored by an organisation operating in a field of endeavour for distribution to selected stakeholders in the field of endeavour, the method comprising the steps of:
A) obtaining independent information on at least one topic of relevance to the field of endeavour;
B) obtaining dependent information, the dependent information related to the organisation;
C) inviting the stakeholders to opt-in for the service;
D) providing the opt-in stakeholders access to the service; and
E) displaying both the independent information and the dependent information to the opt-in stakeholders.

Still in accordance with the present invention, there is provided a method for providing an electronic publishing service, the service sponsored by an organisation in an industry for distribution to stakeholders in the industry, the method comprising the steps of:
A) obtaining independent information on at least one topic of relevance to the industry;
B) obtaining dependent information, the dependent information related to the organisation;
C) inviting the stakeholders to opt-in for the service;
D) providing the opt-in stakeholders access to the service;
E) providing a customized layout in accordance with instructions received from the organisation; and
F) displaying both the independent information and the dependent information to the opt-in stakeholders in accordance with the layout.

Further in accordance with the present invention, there is provided a Web based publication system, the system sponsored by at least one organisation operating in respective fields of endeavour, the system for distribution to stakeholders in the at least one organisation. The system comprises at least one database, at least one server in communication with the at least one database, and at least one client in communication with the at least one server. The at least one database contains independent information on at least one topic of relevance to the respective fields of endeavour and dependent information related to the at least one organisation. The stakeholders in a particular organisation of the at least one organisation are invited to register on the system. The registered stakeholders in the particular organisation have access, using the at least one client, to both the independent information and to the dependent information related to the particular organisation.

Further still in accordance with the present invention, there is provided a server system, the server providing clients communicating therewith access to a publication service, the service sponsored by at least one organisation operating in respective fields of endeavour, the service for distribution to registered stakeholders in the at least one organisation, the registered stakeholders accessing the service using the clients. The server system comprises at least one database and at least one server in communication with the at least one database and configured for communication with the clients. The database comprises independent information on at least one topic of relevance to the respective fields of endeavour and dependent information related to the at least one organisation and information on the registered stakeholders. The registered stakeholders in a particular organisation of the at least one organisation have access to both the independent information and to the dependent information related to the particular organisation.

Finally still in accordance with the present invention, there is provided a publication provided by an independent publication service provider, the publication sponsored by an organisation operating in a field of endeavour for distribution to stakeholders in the organisation who opt-in for receiving the publication. The publication comprises independent information on at least one topic of relevance to the field of endeavour and dependent information related to the organisation and a customized layout designed in accordance with instruction received from the organisation. The independent information and the dependent information are displayed in the publication in accordance with the layout.

Other objects, advantages and features of the present invention will become more apparent upon reading of the following non-restrictive description of illustrative embodiments thereof, given by way of example only with reference to the accompanying drawings.

### BRIEF DESCRIPTION OF THE DRAWINGS

Having thus generally described the nature of the invention, reference will now be made to the accompanying drawings, showing by way of illustration, illustrative embodiments thereof, and in which:

FIG. 1 provides a block diagram of a publication system in accordance with an illustrative embodiment of the present invention;

FIG. 2 provides a flow chart of service provider and sponsor actions in the Web based publication system of FIG. 1;

FIG. 3 provides an exemplary screen display of a publication Website registration page in accordance with an illustrative embodiment of the present invention

FIG. 4 illustrates a conceptual template for an e-mail publication push in accordance with an illustrative embodiment of the present invention;

FIG. 5 provides an exemplary screen display of an e-mail publication push in accordance with an illustrative embodiment of the present invention;

FIG. 6 provides a detailed flow chart of sponsor actions in the Web based publication system of FIG. 1;

FIG. 7 provides a flow chart of stakeholder actions in the Web based publication system of FIG. 1, and illustrates interactions between the stakeholders, the sponsor and the service provider;

FIG. 8 provides an exemplary screen display of a log-in page in accordance with an illustrative embodiment of the present invention;

FIGS. 9A and 9B provide diagrams illustrating the various pages and information respectively associated with the publication and administrator sites in accordance with an illustrative embodiment of the present invention;

FIG. 10 illustrates a conceptual template for a branded publication Website in accordance with an illustrative embodiment of the present invention;

FIGS. 11A and 11B respectively provide exemplary screen displays of a source and a branded publication homepage in accordance with an illustrative embodiment of the present invention;

FIG. 12 provides and exemplary screen display of a sponsor's homepage from which is derived the sponsor skin and layout in accordance with an illustrative embodiment of the present invention;

FIGS. 13A and 13B respectively provide exemplary screen displays of a source and a branded article listings page in accordance with an illustrative embodiment of the present invention;

FIGS. 14A and 14B respectively provide exemplary screen displays of a source and a branded article page in accordance with an illustrative embodiment of the present invention;

FIGS. 15A and 15B respectively provide exemplary screen displays of a source and a branded search page in accordance with an illustrative embodiment of the present invention; and

FIGS. 16A and 16B respectively provide exemplary screen displays of a source and a branded user profile page in accordance with an illustrative embodiment of the present invention.

### DETAILED DESCRIPTION OF THE ILLUSTRATIVE EMBODIMENTS

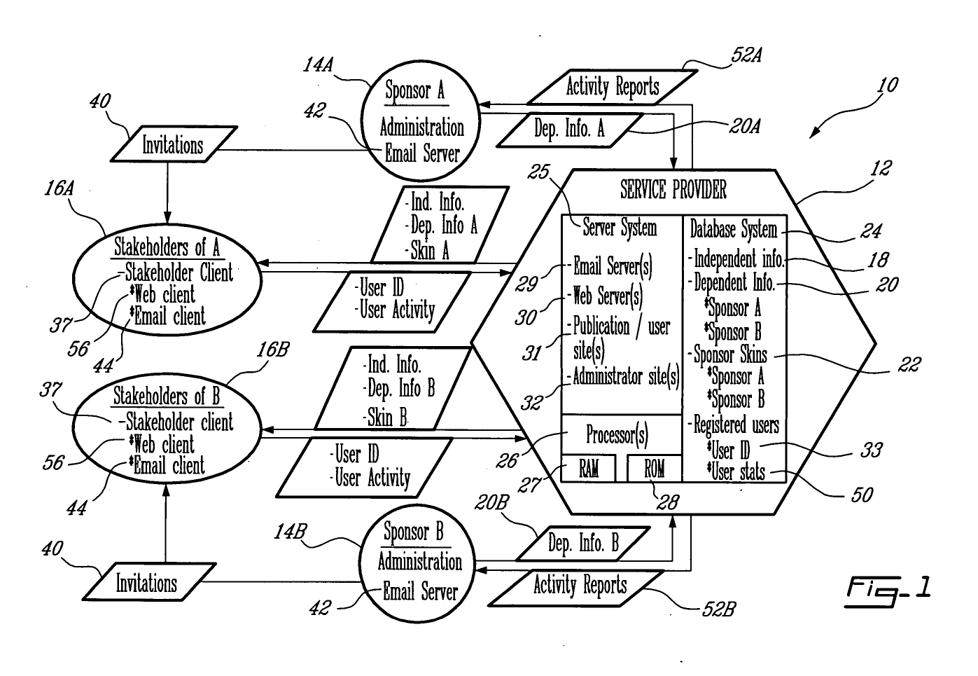

Referring to FIG. 1, a publication system, method and service, generally referred to using the reference numeral 10 and in accordance with an illustrative embodiment of the present invention, will now be presented. The publication system 10 generally comprises an independent service provider 12, at least one sponsoring organisation as in 14, and their respective stakeholders as in 16. In the illustrated example of FIG. 1, the service provider 12 provides a publication service to the sponsoring organisations 14_{A} (Sponsor A) and 14_{B} (Sponsor B), for publishing information to their respective stakeholders 16_{A} and 16_{B}.

The publication system 10 provides an independent publication service to sponsoring organisations 14 for distribution to their respective stakeholders 16. In general, the service provider 12 generates sponsored independent publications for distribution to stakeholders 16 containing both independent information 18, that is information gathered by the service provider from independent news sources not associated with the sponsoring organisations 14, and dependent information 20 provided by the sponsors 14. The gathered independent information 18 generally relates to various topics of relevance to the sponsoring organisation's field of endeavour or industry whereas the dependent information 20 comprises any information selected by the sponsors 14 for distribution to their respective stakeholders 16.

Unlike prior art publication systems, the sponsor 14 provides dependent information 20 to its stakeholders 16 directly using an independent publication service provider 12 that increases publication transparency and credibility to the stakeholder 16. In other words, the stakeholder 16 will receive both the dependent information 20 it wishes to receive and independent information 18 related thereto such that a comparison of the organisation's performance in a given field or industry may be measured with respect to the general performance of other organisations, possibly operating in a same field or industry. This will not only help organisations 14 promote themselves to their respective stakeholders 16, showing by way of unbiased comparison with competitors how they operate in a selected field, but will also provide stakeholders 16 with an independent news source to keep up to date with activities in the field. Ultimately, this type of service will both encourage organisations 14 to improve the quality of their activity in various fields, and provide stakeholders 16 with means for evaluating the performance of organisations 14 within which they are stakeholders. Furthermore, by targeting the stakeholders 16 directly, rather than indirectly through one or plural news services, the sponsoring organisation can better evaluate the reach of their publication.

As will be discussed further hereinbelow, the service provider 12 may also monitor stakeholder readership by providing the publications through a log-in website that allows the service provider 12 to accumulate user activity data, which can be compiled in periodic readership reports for the sponsor 14. In this scenario, the sponsor 14 not only targets its stakeholders directly, but also gets feedback on what topics were found to be interesting to stakeholders 16, whether topics covered by the independent 18 or dependent information 20, and feedback on the general efficiency of the system 10 and its ability to reach targeted stakeholders 16.

For the purpose of illustration, the following embodiments will concentrate on the publication of information pertaining to the sponsoring organisations' Corporate Social Responsibility (CSR) programs and activities. CSR is often subdivided into 5 general topics: Environment, Human Rights, Human Resources, Corporate Governance and Community Involvement. Organisations with an active CSR program will operate in one, a few or all of these fields both out of social responsibility and to promote the organisation to stakeholders in the organisation and/or the organisation's industry. Ultimately, the organisation seeks to increase their reputational capital while participating in socially responsible activities and differentiate itself from competitors in their business through CSR initiatives. Information on such programs and activities is often of great interest to stakeholders 16. Unfortunately, prior art publication systems do not allow for an efficient, measured, unbiased and independent publication of such information.

Prior art systems for distributing CSR information present various drawbacks. One distribution method consists of providing CSR information to stakeholders through stakeholder press packages and newsletters. In this format, all of the information is provided by the organisation, and pushed directly to stakeholders. Alternatively, stakeholders could subscribe to a sponsor mailing list for receipt of such publications. Unfortunately, this method is inherently biased and unilateral, failing to provide stakeholders with transparency vis-à-vis the actual performance of the organisation with respect to other organisations operating in the same and other fields. Furthermore, organisations are unable to supply specific, topical information to CSR interested stakeholders. In a further alternative, the organisation may sponsor publication of its CSR information in an independent physical journal or magazine which publishes non-delineated information to the journal's or magazine's subscribers. Using this traditional media format, the stakeholders often won't know what information is a re-written press release, which may be slanted or biased, and what is original content produced by the reporter. Furthermore, even if the organisation gains some transparency in this method, the information is not directed to the organisation's stakeholders but to the publisher's subscribers which may or may not include a significant subset of the organisation's stakeholders. Additionally, none of the above methods provide a mechanism for receiving readership feedback.

Still referring to FIG. 1, the publication system 10 provides an independent system for providing a publication service to a sponsoring organisation, as in 14, for distribution to stakeholders in the organisation, as in 16. (Note that in an alternative illustrative embodiment discussed further hereinbelow, publications are distributed to stakeholders in the organisation's industry on behalf of the sponsoring organisation, and not specifically to stakeholders in the organisation). Generally, the publications will include independent information 18 gathered by the service provider 12 and dependent information 20 provided by the sponsoring organisation 14, all wrapped in a sponsored branding or skin 22 customised to reflect a “branded” layout recognisable as pertaining to a particular sponsor 14. The service provider 12, through a combination of the independent 18 and dependent 20 information and provision of direct access thereto to interested stakeholders in the sponsoring organisation, provides a publication system 10 that overcomes some of the drawbacks of prior art publication methods, namely on questions of transparency and access to interested stakeholders. As will be discussed further hereinbelow, though the illustrative embodiments of the appended figures discussed herein present a publication system for distribution of CSR information, distribution of any type of information, whether it be related to a specific industry or field of endeavour, can be implemented with the presented system and method 10 without departing from the general scope and nature of the present disclosure.

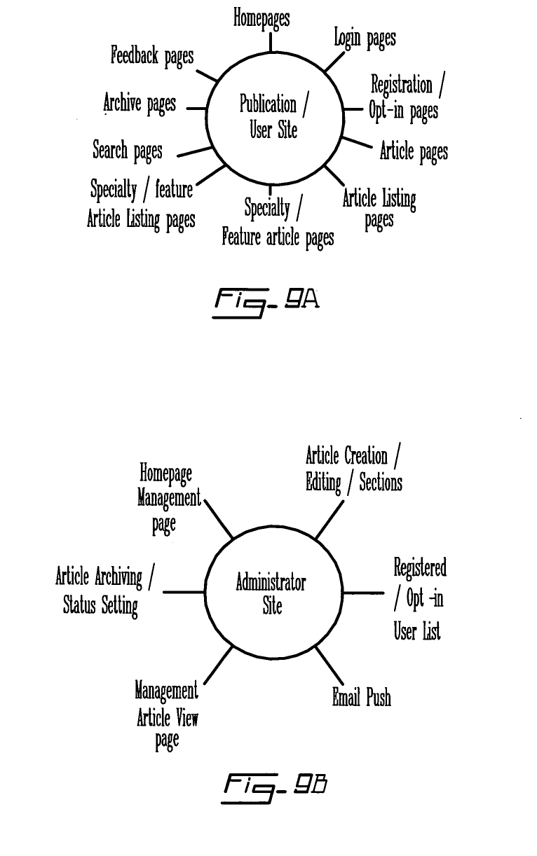

Still referring to FIG. 1, the service provider 12, is generally comprised of a database system 24, a server system 25, and at least one processor 26 having access to RAM 27, ROM 28 and other such computing and processing components. The server system 25, illustratively comprises an e-mail server(s) 29, a Web server(s) 30 as well as a publication/user site(s) 31 and an administrator site(s) 32 implemented therewith (publication and user sites will be discussed further hereinbelow with reference to FIGS. 9 to 16). The database system 24 generally holds the independent information 18 gathered by the service provider 12, the dependent information 20 provided by the sponsoring organisations 14, branding parameters and templates for implementing the sponsor skins 22, and user information 33 on stakeholders registered with the system 10 (stakeholder registration and opt-in procedures and methods will be discussed further hereinbelow).

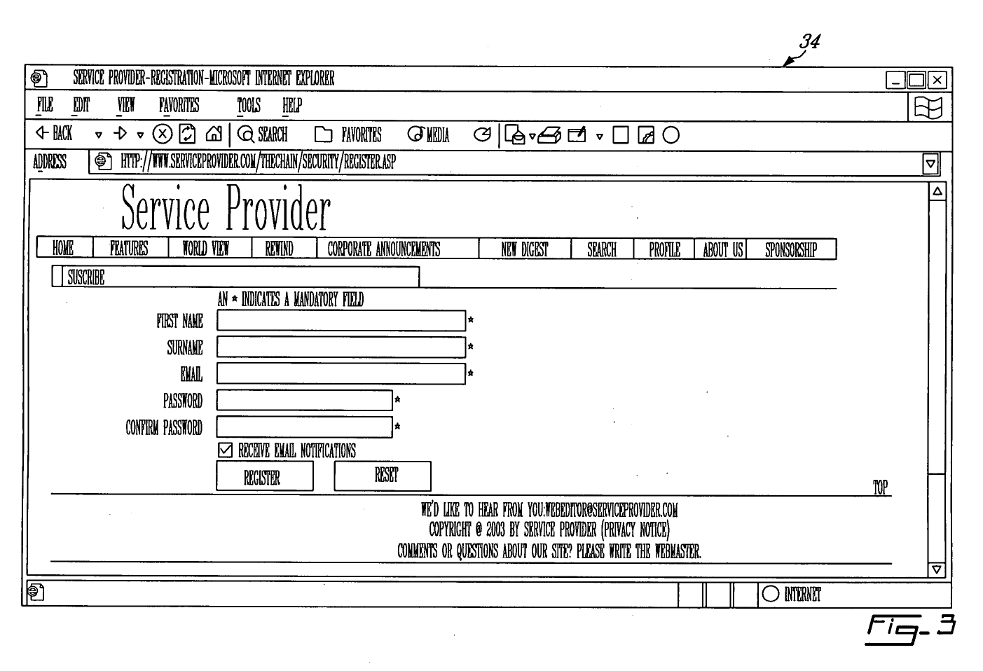

The server system 25, in communication with the database system 24, illustratively provides, amongst others, a registration page 34 (further discussed hereinbelow with reference to FIG. 3) wherein interested stakeholders, as in 16, may opt-in for the publication service 10, and a publication site 31 (further discussed hereinbelow with reference to FIGS. 9 to 16) wherein registered or opt-in stakeholders 16 may browse both the independent information 18 and the dependent information 20 related to the organisation 14 within which they are stakeholders. The publication site 31, in communication with the database system 24, is dynamically constructed using the processor 29 for the display of independent information 18 and dependent information 20 on the stakeholder clients 37 in accordance with a customized layout or skin 22 established cooperatively with each sponsor 14. For example, a registered stakeholder 16_{A} of Sponsor A will have access to a publication website 31 comprising the independent information 18, the dependent information 20_{A} sponsored by Sponsor A, and the sponsor skin 22_{A} established with Sponsor A. Conversely, a registered stakeholder 16_{B} of Sponsor B will have access to a publication website 31 comprising the same independent information 18, the dependent information 20_{B} sponsored by Sponsor B, and the sponsor skin 22_{B} established with Sponsor B. Ultimately, the registered or opt-in stakeholder 16 will gain access to both dependent information 20 related to the sponsoring organisation 14 within which the stakeholder 16 is a stakeholder and independent information 18 pertaining to at least one topic of interest to stakeholders in the organisation's industry or field of endeavour. In addition, the above information will be wrapped in a branded sponsor skin 22 to reflect the sponsor's visual signature. More details concerning the general construction and content of the publication site 31 will be provided further hereinbelow with reference to FIGS. 9 to 16.

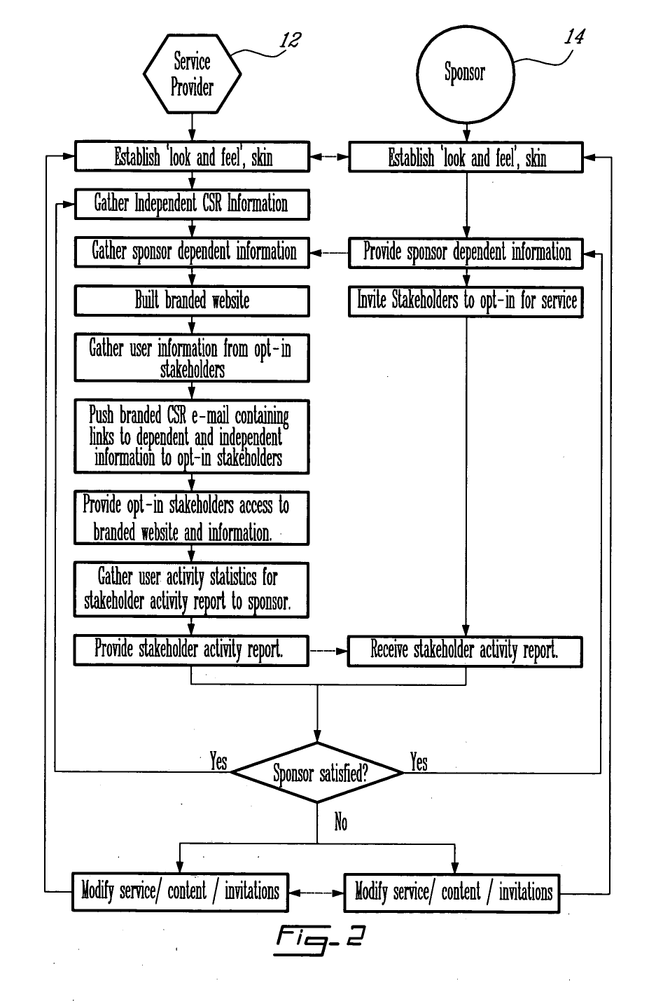

Adding reference to FIG. 2 in conjunction with FIG. 1, the actions of the service provider 12, the actions of a sponsor 14, and the interactions therebetween will now be described. For simplicity, though the system and method 10 may be applied for a plurality of sponsoring organisations 14 and their respective stakeholders 16, we will consider here the interactions between the service provider 12 and a single sponsoring organisation, as in 14. As will become apparent to a person of ordinary skill in the art, extension of the service to plural organisations, as in 14, will require the parallel implementation of the following steps with subsequent organisations.

In a first step, the service provider 12 and the sponsor 14 will cooperatively establish a “branded” Website ‘look and feel’ or skin 22 for the sponsored publications. This skin 22 is used to display the publication to opt-in stakeholders 16 in, or interested in, the organisation 14, in accordance with a layout designed to reflect the visual signature of the sponsoring organisation 14. Note that although a branded layout or skin 22 is implemented in accordance with instructions received by the sponsoring organisation 14, the publication service 10 remains independent and reserves the right to publish in the independent information section of the publication site 31 any information determined to fit within the scope of the publication service and of possible interest to opt-in stakeholders 16.

Once the sponsor 14 and service provider 12 are satisfied with the sponsor skin 22, the service provider 12 will obtain independent information 18 from independent news sources and obtain dependent information 20 from the sponsor 14. Using the gathered information, the service provider 12 proceeds with preparing the sponsored publication site 31. Meanwhile, the sponsor 14 sends to its stakeholders 16 invitations 40 to register and receive the publication service 10. Alternatively, the invitations could be sent out by the service provider 12. In this illustrative embodiment, the invitations 40 are generally comprised of e-mail invitations 40 pushed from a sponsor e-mail server 42 (or service provider server) to respective stakeholder e-mail clients 44. Other invitation formats may include postings on corporate websites, newsgroups and communities, standard invitations forwarded to stakeholders by regular mail, or other such methods.

Stakeholders 16, interested by the publication service 10, will opt-in for the service 10 using the service provider's registration page 34, an exemplary screen display of which being provided in FIG. 3. In one illustrative embodiment, the e-mail invitations 40 provide stakeholders 16 with a hyperlink to a registration page 34 on the service provider's Web server 27. Interested stakeholders can thus access the registration page 34 directly, wherein they may input user information 33 such as their name, e-mail address and password. This user information 33 will then be stored in the database system 24 to provide the opt-in stakeholders 16 access to the sponsored publication site 31. The user information 33 stored in the database system 24 will also include the sponsor ID in order to provide the opt-in stakeholder 16 access to the appropriate publication site 31, that is the version of the publication site 31 branded in accordance with the inviting sponsor's skin 22 and providing access to the inviting sponsor's dependent information 20. The sponsor ID will either be automatically recorded in the registration hyperlink, thereby providing either a branded or unbranded sponsor-specific registration page 34, or the sponsor ID may be provided manually by the stakeholder 16 during registration. Alternatively, the sponsor 14 can provide the service provider 12 with a list of invited stakeholders, whereby a stakeholder 16 who opts-in for the service will automatically be cross-referenced with the list of potential users, thereby associating the registering stakeholder with an appropriate sponsor ID. A person of ordinary skill in the art will understand that other such opt-in and registration methods can be implemented to obtain substantially the same result without departing from the general scope and nature of this disclosure. Ultimately, any system, method or procedure allowing the interested and/or invited stakeholder to opt-in or register for the publication service 10, thereby allowing the stakeholder name and contact information to be included on a distribution list for providing the stakeholder access to service provider publications, may be considered in the publication system 10.

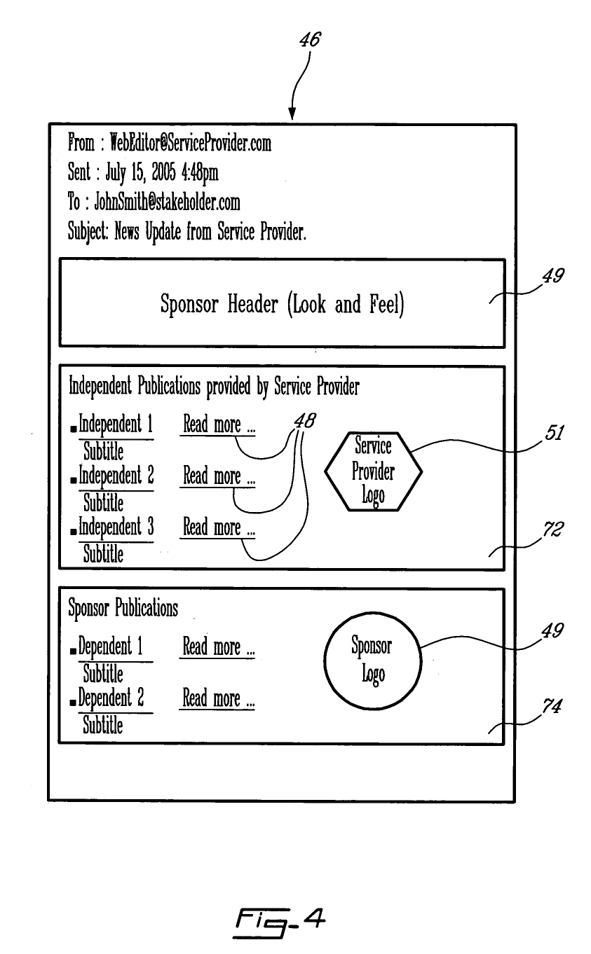

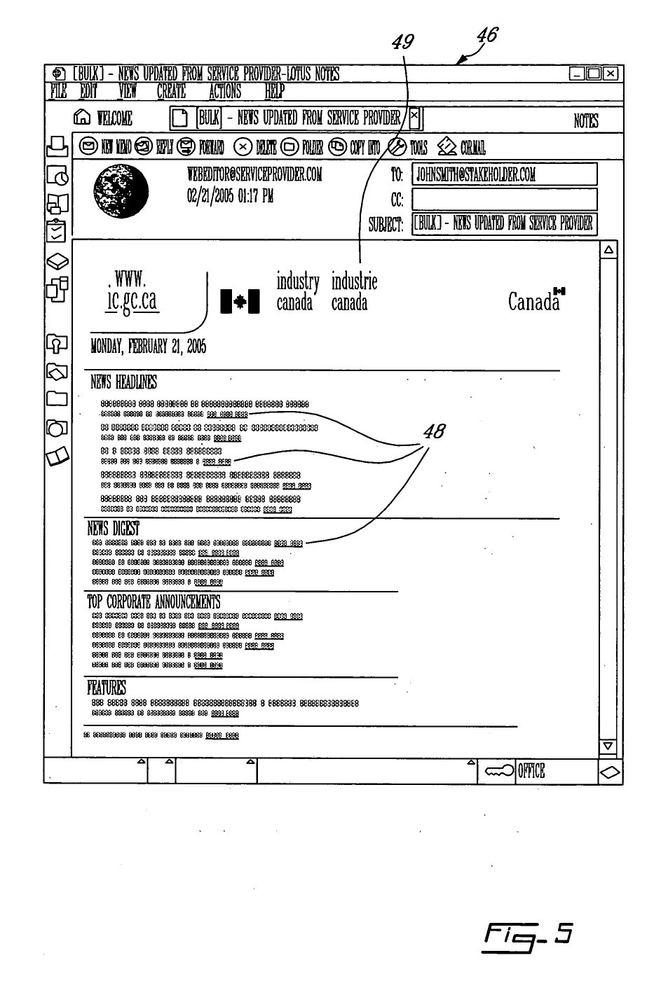

Once a list of opt-in stakeholders is compiled, the service provider 12 sends out a branded HTML e-mail push 46 to the opt-in stakeholders 16 (e.g. every week, month, etc. as defined by the sponsor 14). These pushes, an illustrative template of which being presented in FIG. 4 and an exemplary screen display of which being presented in FIG. 5, illustratively contain links 48 to information published on the branded publication site 31, branded ‘look and feel’ elements 49 such as banners, logos, fonts and other such display features reflecting the sponsor's visual signature, as well as optional sponsor links to other sponsor Web content and promotions (not shown). The E-mail pushes 46 may also optionally comprise service provider logos or features, as in 51.

As the opt-in stakeholders browse the branded publication site 31, the service provider 12 optionally gathers user activity statistics 50 used to provide readership reports 52 to the sponsor 14. Such compiled statistics may include information on how many people accessed the publication site 31, what was read and by what set of stakeholders, how much time was spent reading each article, how much time was spent reading dependent verses independent information, as well as general user aggregate statistics from stakeholders in other sponsoring organisations active in the system 10. Upon receipt of the report 52, the sponsor may evaluate the efficiency and reach of their dependent information, and possibly select to make adjustments before the next publication.

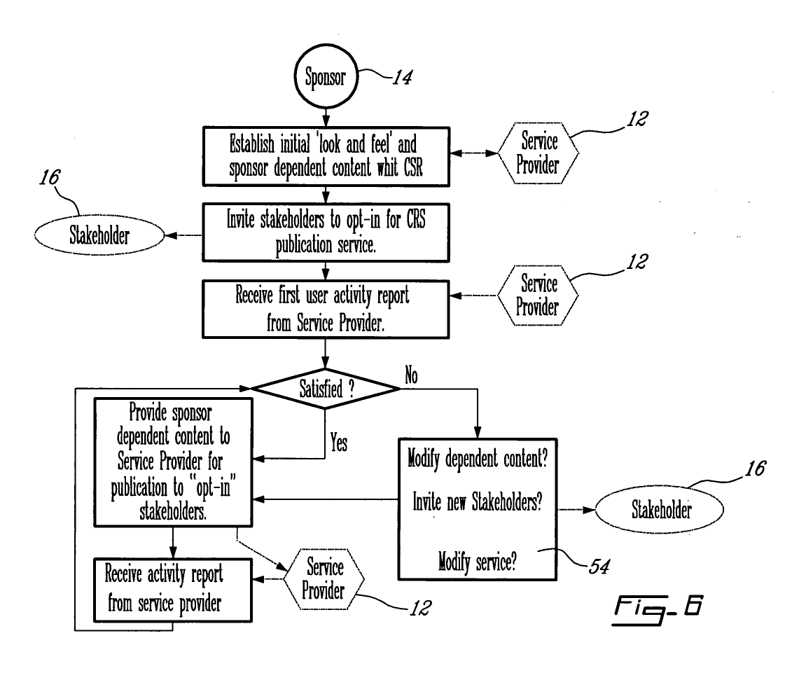

Referring now to FIG. 6 in conjunction with FIG. 1, the sponsor actions and interactions with their stakeholders 16 and the service provider 12 are described in greater detail. As described hereinabove with reference to FIG. 2, the sponsor first establishes the ‘look and feel’ of the sponsored publication site 31 with the service provider 12 and provides the service provider 12 with the dependent information 20 they seek to publish. Note that the dependent information 20 may include any information relating to the sponsor 14 such as, but not limited to, information about the organisation's CSR activities and programs, information pertaining to the organisation's operations in related and unrelated fields, as well as advertisements and promotional material on the organisation's products and services. In this CSR context, the sponsor 14 seeks to promote its CSR activity to stakeholders 16 while providing additional information of possible interest to them. The sponsor 14 may either provide full written advertorials to the service provider 12, or again provide the raw information to writers within the service provider 12 who can then take charge of drafting and formatting the dependent information 20 for publication as a service to the sponsor 14. Before the dependent information is loaded in the dependent information content of the publication, the sponsor 14 receives a draft of the “outsourced” content for final approval.

The sponsor 14, or alternatively the service provider 12 as discussed hereinabove, then invites the stakeholders 16 to opt-in for the service 10. As described hereinabove, the stakeholders 16 receive an invitation 40 guiding them to the registration page 34 (FIG. 3) to state interest in gaining access to the publications from the service provider 12. At the end of a predetermined period, once invited stakeholders have had time to access the publication site 31, the sponsor 14 will receive a user activity report 52 from the service provider 12, from which the sponsor 14 may assess the efficiency and reach of the service 10. At that point, the sponsor 14 may select to proceed without change, thereby providing new dependent information 20 to the service provider 12 for a subsequent publication and activity report 52, or select to change certain service parameters, as in 54. For example, the sponsor 14 may select to change the sponsor skin 22, send new invitations 40 either to the same stakeholders 16 or to a new set of stakeholders 16, or discuss changes in the system 10 itself with the service provider 12. Such system modifications could include user statistics monitoring and reporting procedures and guidelines, content formatting and arrangements, periodicity of publication pushes, etc. In one exemplary scenario, the sponsor 14 could also conduct an online survey with their stakeholders using the system 10 to better determine stakeholder interests and modify their dependent content accordingly. Once the sponsor 14 is satisfied with the new arrangement, new dependent information 20 is periodically provided to the service provider 12 for periodic publications and subsequent user activity reports 52.

Ultimately, the service provider 12 provides an independent news source to its users, namely stakeholders 16 in sponsoring organisations 14, and remains unbiased in the selection of independent information 18 it chooses to publish. Consequently, a publication may contain both negative independent information 18 and positive dependent information 20 relating to a same sponsoring organisation 14. In order to remain unbiased and independent, the service provider 12 should not be influenced by any sponsoring organisation 14 to refrain from publishing potentially damaging independent information related thereto. In one illustrative embodiment, the sponsoring organisation 14 effected by such a negative disclosure could defend itself by providing a responding dependent article in a subsequent publication. In this case, the sponsor 14 could assume that stakeholders who read the first negative article would also have access to the response. In an alternative illustrative embodiment, the service provider 12 could warn the organisation 14 that a negative article will be published in a future publication, and allow the organisation the opportunity of providing an article in response thereto for distribution in a same publication. In this latter scenario, the service provider 12 maintains its integrity, while providing the sponsor 14 with an opportunity of defending itself or providing clarifications.

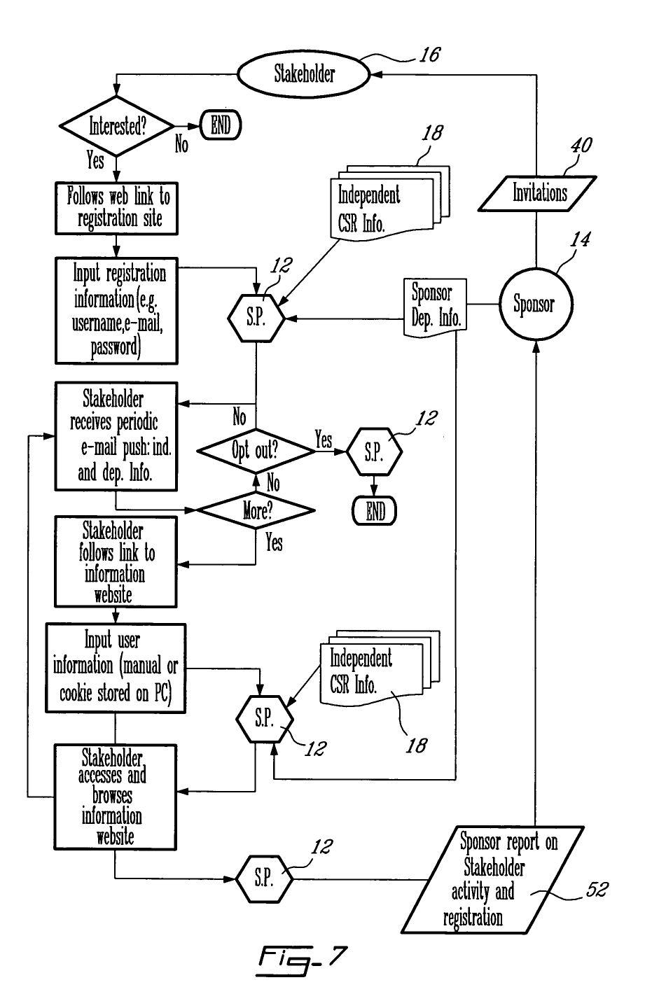

Referring to FIG. 7 in conjunction with FIG. 1, the system 10 will now be presented from the stakeholder's point of view. In the system 10, the stakeholder 16 in a sponsoring organisation 14 receives an invitation 40 to an independent CSR publication system 10. In this illustrative embodiment, the invitation 40 is received by e-mail through the stakeholder's e-mail client 44 from the sponsor 14. Alternatively, the invitations could also be sent out by the service provider 12. The stakeholder 16 is informed in the invitation 40 of the service's particularities and function and is invited to access a registration page 34 (FIG. 3) to opt-in for the service. If the stakeholder 16 is not interested, the stakeholder 16 can ignore the invitation 40 and should receive no further correspondence, unless of course new invitations 40 are sent. To avoid subsequent invitations to uninterested stakeholders, the invitation 40 could provide means for removing the stakeholder's name and/or contact information from a list used to expedite future invitations. As will now be apparent to a person of ordinary skill in the art, the stakeholder may also be informed and requested to opt in for the service 10 by other methods including, but not limited to, newsletters, advertisements, and other such methods, wherein the stakeholder could be directed to a Web form or registration page 34 as noted above.

If the stakeholder 16 is interested in the service 10, the stakeholder 16 can follow a link in the invitation to the registration page 34 (FIG. 3) and provide the requested user information 33 (e.g. username, e-mail, password, etc). As discussed hereinabove, the user information 33 on the opt-in stakeholder 16 will also include a sponsor ID associated therewith. This sponsor ID is either provided manually by the stakeholder 16, provided electronically by cross-referencing the stakeholder's name with a stakeholder list provided by the sponsor 14, or again determined automatically from the invitations hyperlink leading to a sponsor-specific registration page 34. Upon registration, a cookie, or other such automatic user identification means, may also be created on the stakeholder client 37 for accelerated access to the branded publication site 31 on future visits.

After registration, the stakeholder 16 will receive periodic e-mail publication pushes 46, as discussed hereinabove with reference to FIGS. 4 and 5, from the service provider 12. These pushes 46, as mentioned hereinabove, illustratively provide hyperlinks 48 to the independent 18 and dependent 20 information published on the publication site 31.

If the stakeholder 16 is not interested in the listed topics provided by the e-mail push 46, the stakeholder 16 may either wait for subsequent publications, or simply opt-out of the service 10, after which point no more publications should be sent out to the stakeholder 16.

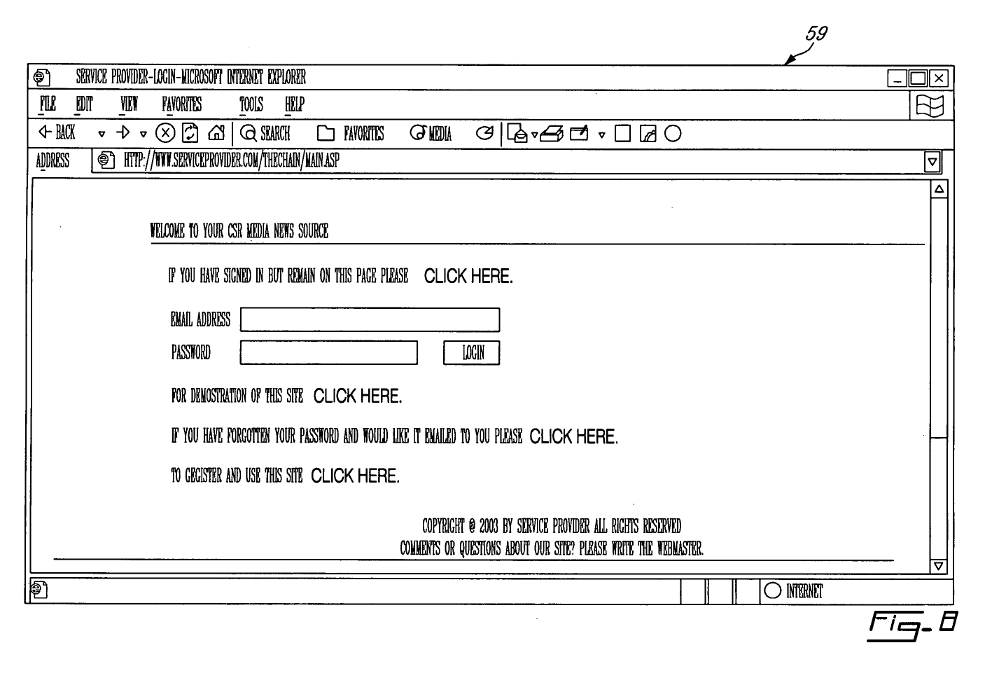

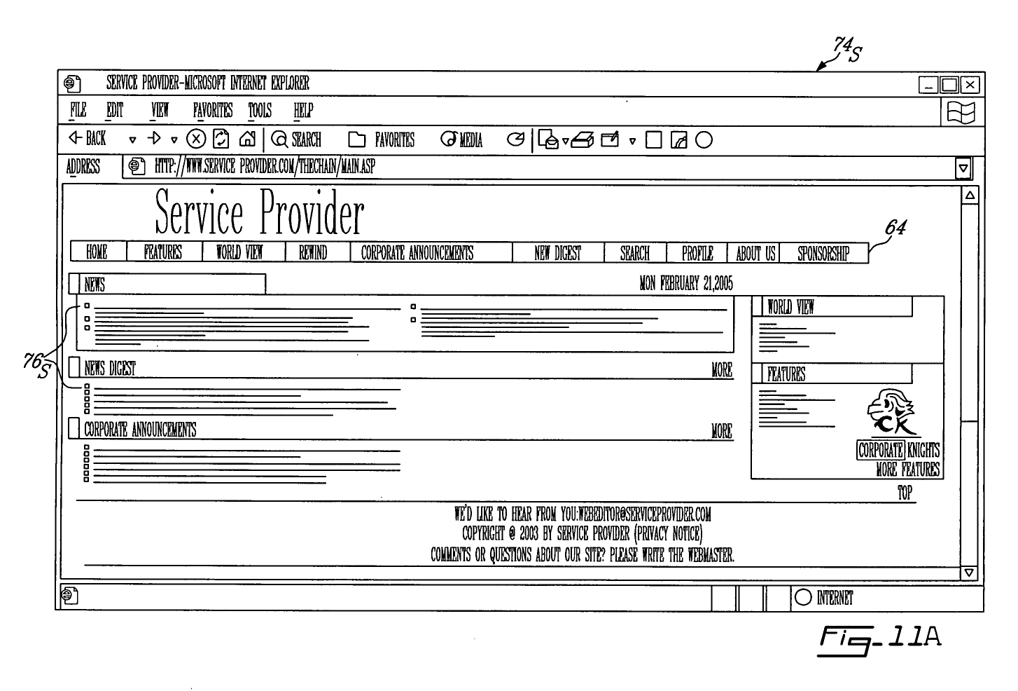

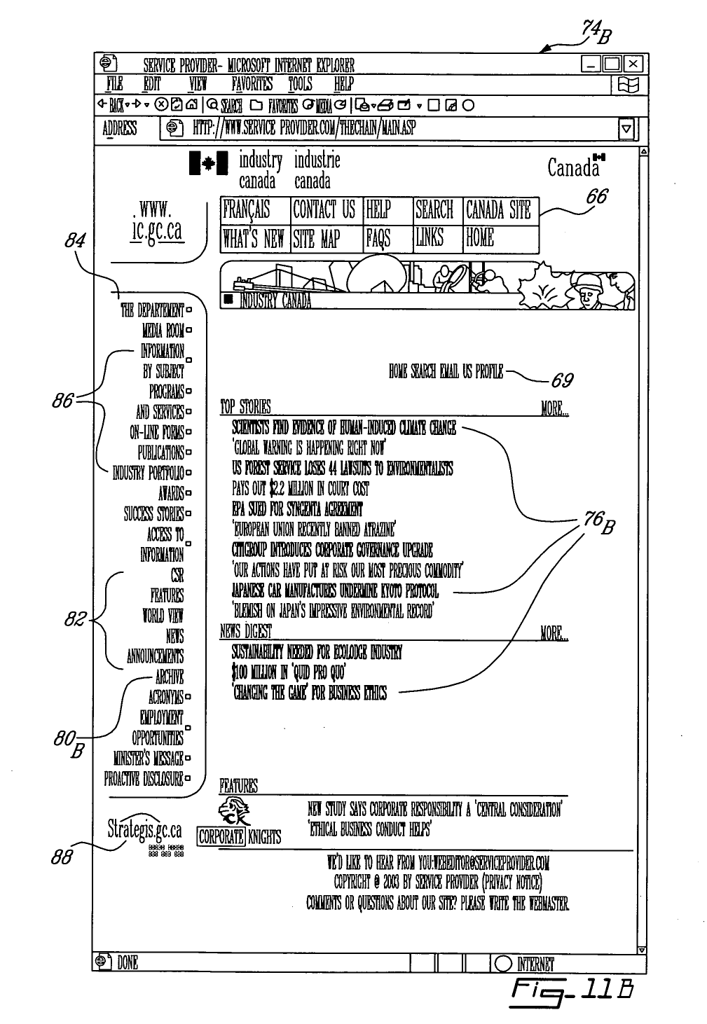

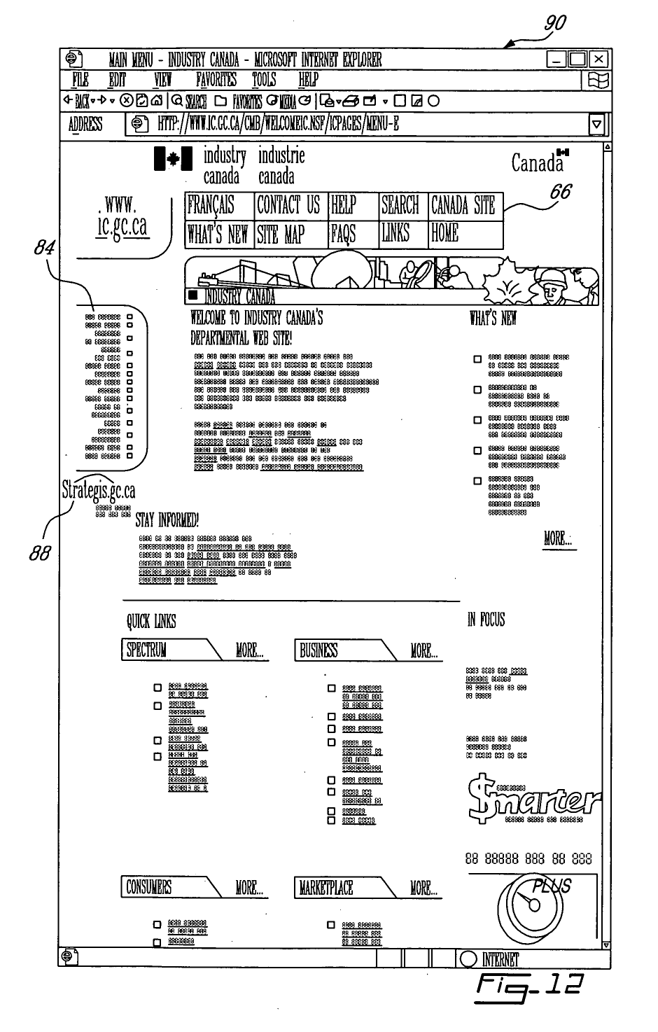

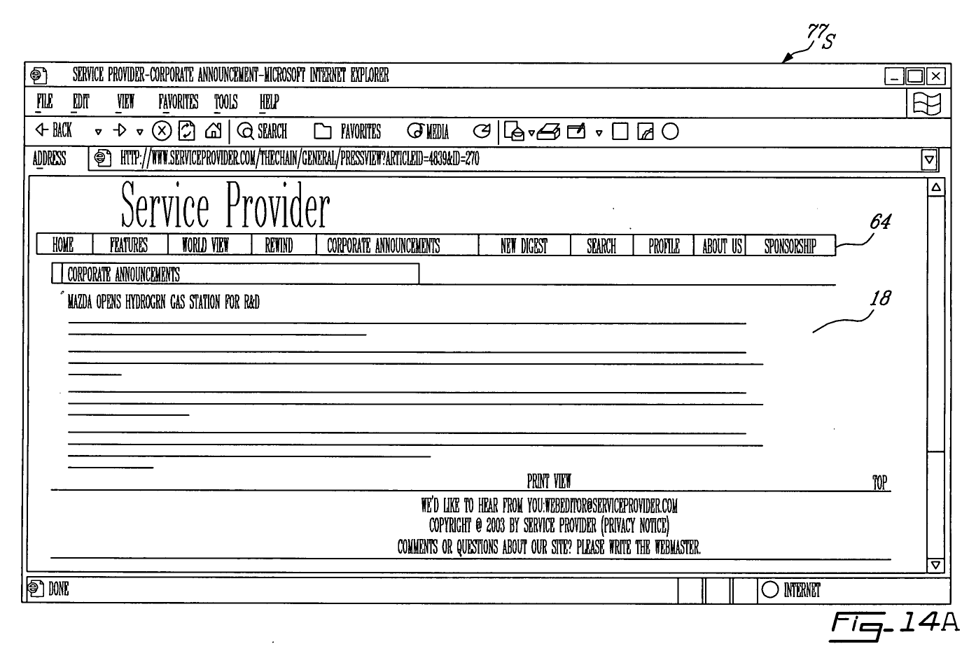

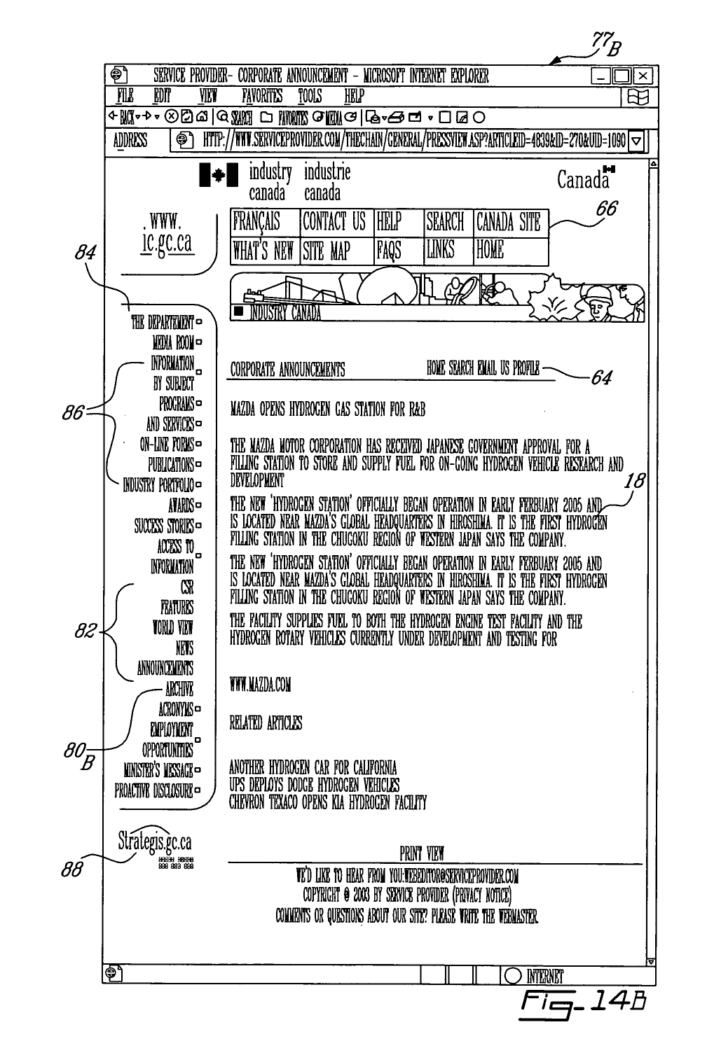

On the other hand, if the stakeholder 16 is interested in the listed information of the e-mail push 46, the stakeholder may select to read more on any given topic and follow one of the links 48 to the publication site 31 (described further hereinbelow with reference to FIGS. 9 to 16). If a cookie or other such identification file is stored on the stakeholder client 37, the stakeholder 16 may access the branded publication site 31 directly using the links 48 in the e-mail push 46. For example, by selecting one of the links 48 of the e-mail push 46, the stakeholder 16 may be directed to a branded article page (as illustrated in FIG. 14B) corresponding thereto. Alternatively, all links 48 in the e-mail push 46 may lead to a branded homepage (as illustrated in FIG. 11B) offering links thereon to the articles. If on the other hand the cookie is deleted, or again never created, a user login page 59, an exemplary screen display of which being presented in FIG. 8, is first presented to the stakeholder 16, wherein the stakeholder 16 may enter his username and password to access the branded publication site 31. As the logged-in stakeholder 16 browses the publication site 31, the service provider 12 monitors the activity of the stakeholder 16 for compilation of user activity statistics 50 used to prepare activity reports 52 sent to the sponsor 14.

Referring now to FIGS. 9 to 16, and in accordance with an illustrative embodiment of the present invention, the service provider Websites, as well as some of their options and functionalities, will be described in greater detail.

Referring now to FIG. 1 in addition to FIGS. 9A and 9B, the general components and/or pages of the service provider's publication/user site 31 and administrator site 32 are respectively illustrated. The user site 31 (FIG. 9A) illustratively provides access to all the pages related to the functions and features accessible to the opt-in stakeholder 16. Such pages include, but are not limited to, homepage(s), feedback page(s), archive page(s), search page(s), login page(s), article page(s), article listing page(s), specialty/feature article page(s), specialty/feature article listing page(s), etc. On the other hand, the administrator site 32 (FIG. 9B) illustratively provides access to all the pages and information related to the functions and features accessible to and needed by an administrator, administrators including writers, web managers, web designers, skin developers and the like. These pages and information include, but are again not limited to, homepage management page(s), article archiving/status setting page(s), management article view page(s), e-mail push management page(s), registered/opt-in user list page(s), article creation/editing page(s), etc. Both of these sites may have access to the information stored on the database system 24 for the creation and presentation of the independent information 18 and dependent 20 information in accordance with sponsor layouts and skins 22 to the opt-in stakeholders 16.

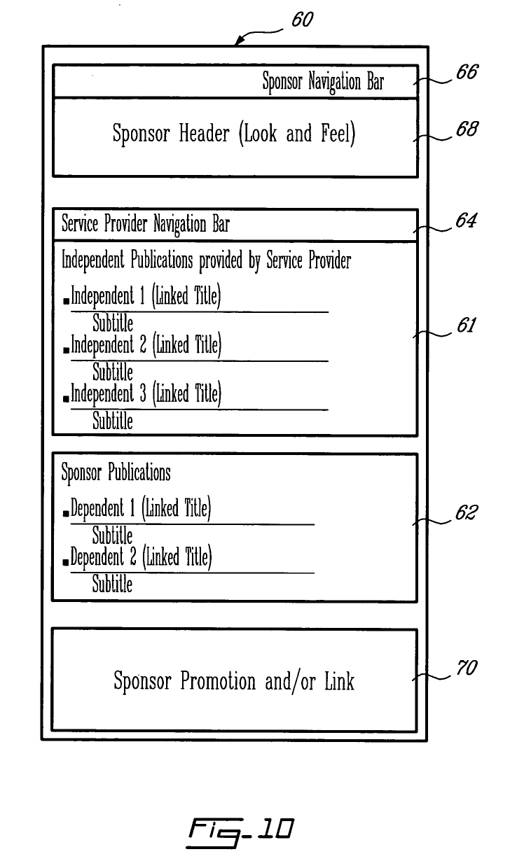

Referring now to FIG. 10 in addition to FIG. 1, a conceptual template 60 for the structure of publication site 31 is presented. The publication site 31 illustratively comprises an independent information section 61, a dependent information section 62, a service provider navigation bar 64, a sponsor navigation bar 66, sponsor ‘look and feel’ elements such as a sponsor header banner 68 and other such elements defining the sponsor skin 22, as well as potential sponsor promotional material or advertisements and/or links 70.

Referring now back to FIG. 4 in addition to FIG. 10, the independent information section 61 and the dependent information section 62 of the conceptual site template 60, are illustratively correlated to the independent information section 72 and the dependent information section 74 of the publication e-mail push 46 respectively. For example, the links 48 of the e-mail push 46 should provide access to substantially the same information as the links 76 of the conceptual template 60 and publication site 31. As will now be apparent to a person of ordinary skill in the art, the site structure illustrated in FIG. 9 presents certain important elements of an illustrative embodiment of a publication site 31, forming an illustrative conceptual basis for the construction thereof.

Referring now to FIGS. 11 to 18, exemplary screen displays comparing source pages and branded pages will be presented. In these figures, the service provider 12 bears the name of Ethike, whereas the sponsor 14 is Industry Canada. As will be apparent to a person of ordinary skill in the art, these figures provide examples only of a possible implementation and display of publication site 31. Other Web based features, functions and components may be added or removed from these embodiments without departing from the general scope and nature of this disclosure.

Referring first to FIGS. 11A and 11B, in conjunction with FIG. 10, an example of a source publication site homepage 74_{S} and a corresponding branded homepage 74_{B} are presented. (For clarity, the subscript S will now be used to identify an item relating to a source page and the subscript B will be used to identify a same item relating to a corresponding branded page).

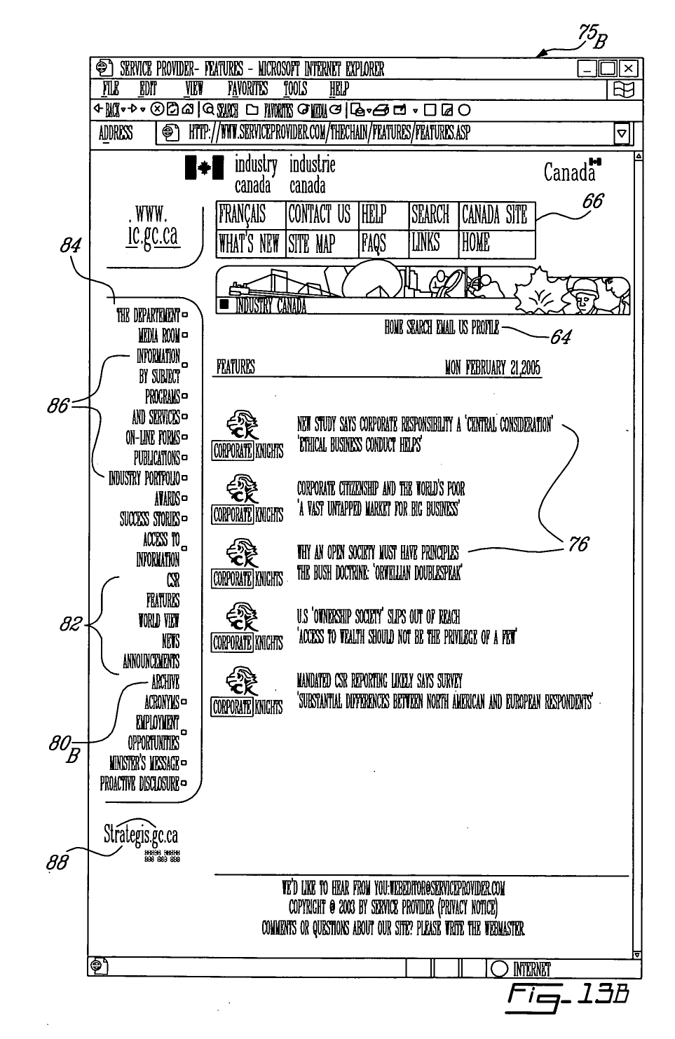

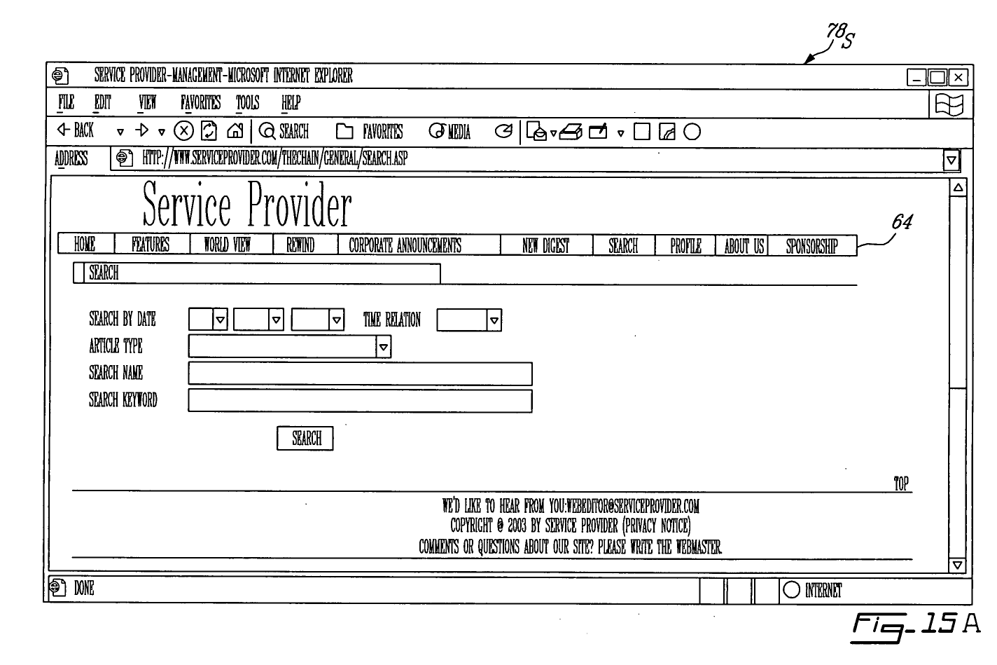

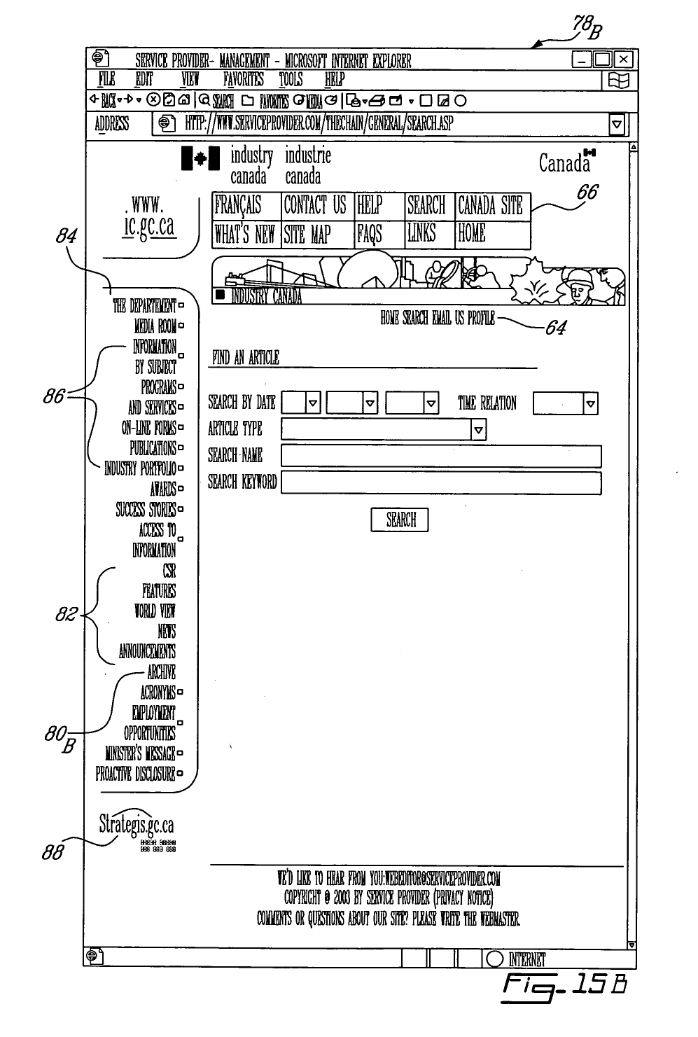

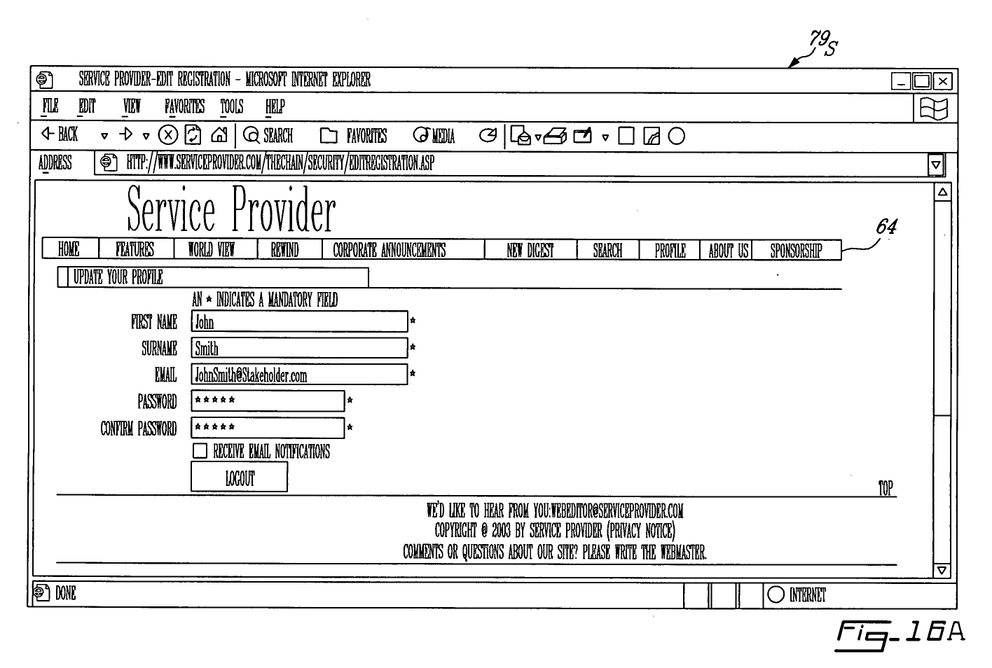

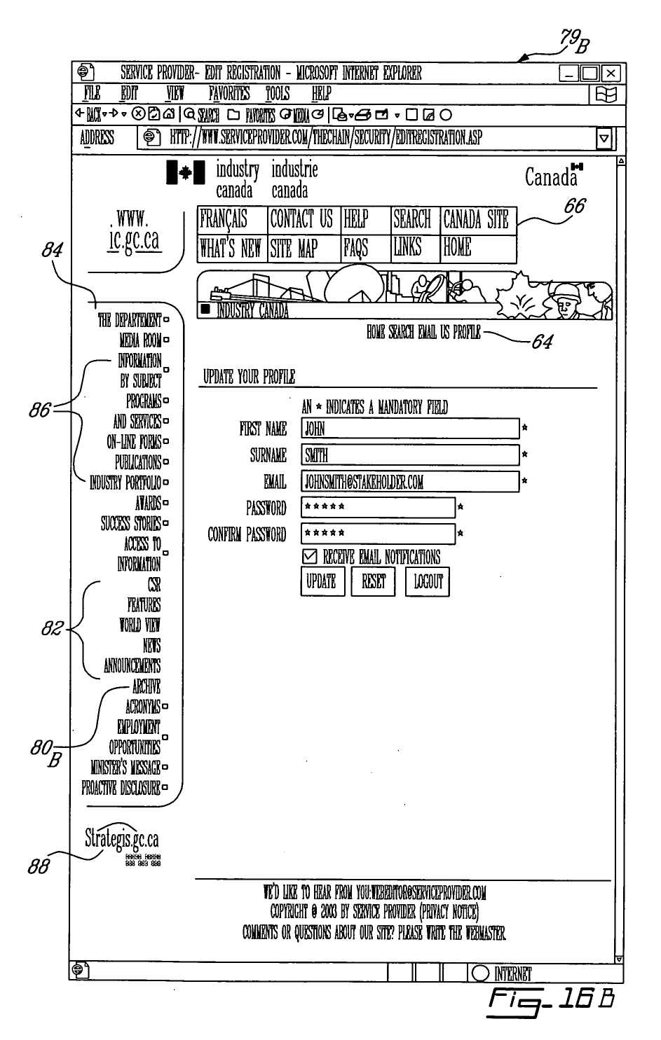

In FIG. 11A, in addition to FIG. 1, the source homepage 74_{S} illustratively comprises a plurality of independent information links 76_{S} subdivided into various categories including, but not limited to, News, News Digest, Corporate Announcements, World View and Features. The links 76_{S} either lead to a corresponding article listing page (as in 75_{S} of FIG. 13A), article page (as in 77_{S} of FIG. 14A) or other such article oriented pages. In addition, the source homepage 74_{S} also comprises a service provider navigation bar 64 comprising links to, for example, various article listing pages (again as in 75_{S} of FIG. 13A) such as World View, Corporate Announcements, News Digest and so on, as well as links to a “Search” page (as in 78_{S} of FIG. 15A) for searching the database system 24, a “Profile” page (as in 79_{S} of FIG. 16A) for updating user information 33, an “About Us” page for obtaining further information about the service provider 12, a “Rewind” page for accessing previous publications, and other such pages for accessing further information.

In FIG. 11B, the branded homepage 74_{B} also illustratively comprises a plurality of independent information links 76_{B} subdivided into various categories including, but not limited to, Top Stories (replacing the News header in 74_{S}), News Digest and Corporate Announcements. The categories World View and Features listed in the source homepage 74_{S}, though not explicitly laid out in the main frame of the homepage 74_{B}, are included as links 80_{B} in the independent CSR navigation section 82 of the sponsored site's navigation menu 84. The links 76_{B} and 80_{B} again either lead to a corresponding branded article listing page (as in reference 75_{B} of FIG. 13B), branded article page (as in reference 77_{B} of FIG. 14B) or other such branded article oriented pages. In addition, the branded homepage 74_{B} also comprises a modified service provider navigation bar 64 illustratively comprising links to, for example, a branded “Search” page (as in reference 78_{B} of FIG. 15B) for searching the database system 24, a branded “Profile” page (as in reference 79_{B} of FIG. 16B) for updating user information 33, an “e-mail Us” page for corresponding directly with the service provider 12, and other such pages.

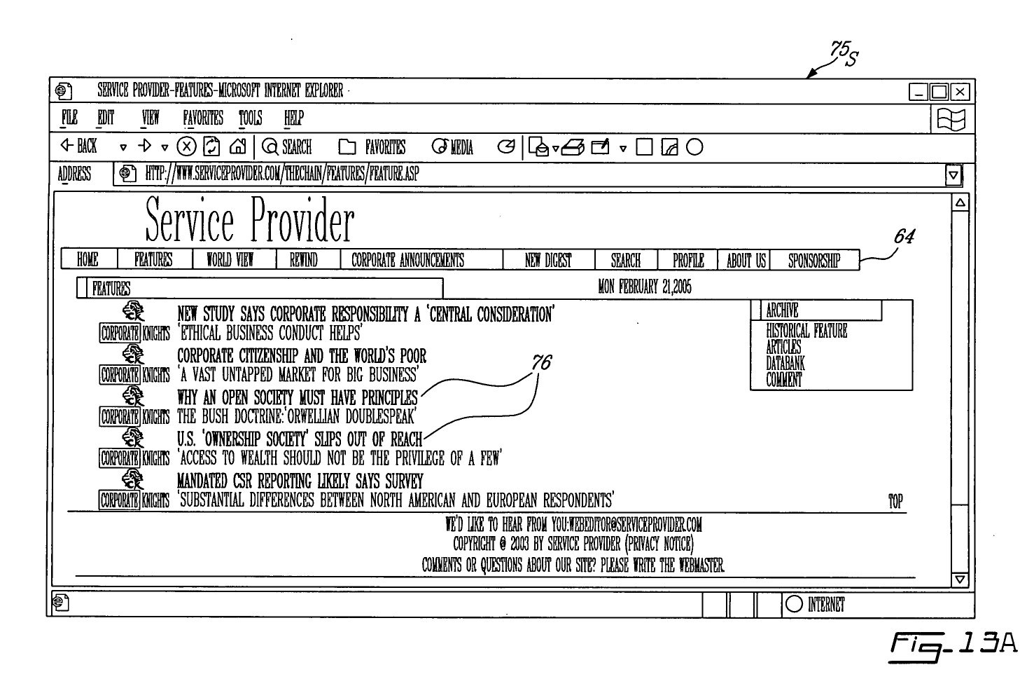

Still referring to FIG. 11B, and additionally to FIG. 1, the branded homepage 74_{B} also includes dependent information 20 and dependent information links 86, as well as a sponsor navigation bar 66, a sponsor navigation menu 84 and sponsor related links as in 88. These features, which do not appear on the source homepage 74_{S}, provide opt-in stakeholders 16 access to various types of sponsor dependent information 20. As discussed hereinabove, the branded Homepage 74_{B} is also configured to reflect a layout and skin 22 corresponding to a sponsor's visual brand. In a modest customization, the sponsor 14 will limit skin components to simple banners, icons and logos. In a complete customization, the sponsored site 31 will take on the exact display layout and format of the sponsor's own private site. The exemplary screen display of FIG. 11B provides an illustrative example of the latter scenario. When comparing the sponsored homepage 74_{B} of FIG. 11B to the private Industry Canada homepage 90 of FIG. 12, a substantially identical layout and skin is observed.

Using the independent publication service 10, as described herein with reference to the appended figures, and in particular to FIG. 1, many of the drawbacks of prior art publication systems are overcome. Namely, a sponsoring organisation gains direct access to its stakeholders through an independent publisher. That means that, unlike journals, magazines and other such independent publishers, the information is sent to the organisation's stakeholders and not to the publisher's stakeholders. This ensures greater publication focus, reach and efficiency. Futhermore, since the sponsored information is provided to the stakeholders through an independent publisher that also provides independent information on subjects of interest to the stakeholders and of relevance to the sponsor's industry or field of endeavour, the stakeholder is better positioned to evaluate the value, accuracy and credibility of the sponsored information 20.

In addition, to increase the sponsor's incentive to use the independent publishing service, the sponsored information may be presented as an advertorial, or again be coupled with promotional information, in order to encourage stakeholder involvement with the organisation. Ultimately, a stakeholder accessing the publication system 10 will be doing so in an atmosphere designed to reflect the sponsor's own visual and interactive signature. Once the stakeholer's attention is grabbed by the publications, it may be guided towards further sponsor information and services. Namely, the stakeholder may be encouraged to browse the sponsor's website, thereby allowing the sponsor to use the publication system 10 as a means for delivering its goods and services to targeted opt-in stakeholders. In a sense, the service may act in part as a permission-based sales opportunity. With that option, the sponsor can measure the ROI of sponsorship not only in terms of readership communication activity and interest but also in strict cash terms. For example, the sponsor may determine the number of sales generated from the sponsored site, what was sold and to whom, what type of visual or published data prompted the buy, was the buy generated through an announcement or through a link in the sponsored skin, and other such useful information.

In the above illustrative embodiments, the publication system 10 is used to distribute CSR information. In an alternative illustrative embodiment, the system 10 can be used to distribute information pertaining to any industry or field of operation. For example, a system as in 10 could be used in the shipping industry. The independent information 18 gathered by the service provider 12 could relate to various topics of interest to stakeholders in the shipping industry, namely shipping strategies and practices, estimated costs, international cooperatives and partnerships, transportation rules and regulations, and other such topics. Sponsors in this alternative system 10 would generally comprise of organisations operating in the shipping industry, whether they be import/export agencies, international shipping organisations, consultant firms, and the like. These shipping industry sponsors would then invite stakeholders in their organisation to the publication system 10, wherein opt-in stakeholders would gain access to both independent information and dependent information pertaining to the organisation within which they are stakeholders. Again, the sponsored sites would provide the information in accordance with a layout and skin customized to reflect the sponsor's visual signature.

As will now be apparent to a person of ordinary skill in the art, other examples of industries and fields of operation wherein such a system could be applied may include, but are not limited to, the foods industry, the petroleum industry, the pharmaceutical industry, provision of legal services, and other such fields and industries.

In a further alternative illustrative embodiment, the system 10 could also be used by a sponsoring organisation to provide stakeholders in the organisation's industry, and not specifically stakeholders in the sponsoring organisation, access to independent information of relevance to the industry and to dependent information related to the sponsoring organisation. In this further alternative embodiment, the sponsoring organisation seeks to promote itself, and its operations in the industry, to stakeholders in the industry that might not be stakeholders in the sponsoring organisation. This alternative method may be used to promote new stakeholder involvement with the sponsoring organisation.

As will now be apparent to a person of ordinary skill in the art, other embodiments of the publication system 10 may be designed using other web based and conventional publication means and technologies. For instance, though the above disclosure presents an embodiment of the publication system 10 wherein publications are first announced by HTML e-mail pushes and then accessed on a sponsored Website, the full branded publication could also be forwarded to the opt-in stakeholders by e-mail, thereby removing the need for a publication Website. Yet, the Website could still be kept active for access to archived documents and previous issues.

In a further alternative, the pushed e-mail publication notice could be used exclusively to announce the new publication, without providing any publication highlights and links. The opt-in stakeholder could then access the new publication from a Web browser, or again download it from the server directly.

Finally, it is to be understood that the invention is not limited in its application to the details of construction and parts illustrated in the accompanying drawings and described hereinabove. The invention is capable of other embodiments and of being practised in various ways. It is also to be understood that the phraseology or terminology used herein is for the purpose of description and not limitation. Hence, although the present invention has been described hereinabove by way of illustrative embodiments thereof, it can be modified, without departing from the spirit, scope and nature of the subject invention as defined in the appended claims.

What is claimed is:

1. A method for providing a service for publishing information, the service sponsored by an organisation operating in a field of endeavour, the published information for distribution to stakeholders in the field of endeavour, the method comprising the steps of:
obtaining independent information on at least one topic of relevance to the field of endeavour;
obtaining dependent information, said dependent information related to the organisation;
inviting the stakeholders to opt-in for the service;
providing said opt-in stakeholders access to the service; and
displaying both said independent information and said dependent information to said opt-in stakeholders.

2. The method as in claim 1 further comprising the step of selecting a subset of stakeholders in the field of endeavour, wherein the step of inviting the stakeholders consists of inviting said subset of stakeholders.

3. The method as in claim 2, wherein said subset consists of stakeholders in the organisation.

4. The method as in claim 1, wherein a customised layout for displaying said independent information and said dependent information is provided in accordance with instructions received from the organization, said independent information and said dependent information being displayed according to said layout.

5. The method as in claim 1, wherein the step of inviting the stakeholders comprises sending an e-mail invitation to the stakeholders.

6. The method as in claim 5, wherein said e-mail invitation is sent by the sponsoring organisation.

7. The method as in claim 5, wherein said e-mail invitation is sent by a provider of the electronic publication service.

8. The method as in claim 5, wherein said e-mail invitation comprises a link to a registration website, the stakeholders opting-in for the service by accessing said registration website through said link.

9. The method as in claim 1, wherein said independent information and said dependent information is displayed on an e-mail, said opt-in stakeholders having access to said e-mail.

10. The method as in claim 1, wherein said independent information and said dependent information is displayed on a Website, said opt-in stakeholders having access to said Website.

11. The method as in claim 1, wherein said displaying step comprises the step of sending a publication e-mail push to said opt-in stakeholders to announce a new publication.

12. The method as in claim 11, wherein said publication e-mail push is an HTML e-mail push.

13. The method as in claim 11, wherein said publication e-mail push comprises said independent information and said dependent information.

14. The method as in claim 11, wherein said publication e-mail push comprises promotional information related to the organisation.

15. The method as in claim 11, wherein a customised layout for displaying said publication e-mail push is provided in accordance with instructions received from the organization, said publication e-mail push being displayed according to said layout.

16. The method as in claim 11, wherein said publication e-mail push comprises at least one hyperlink to a Website comprising said independent information and said dependent information, said opt-in stakeholders following said at least one hyperlink to access said independent information and said dependent information on said website.

17. The method as in claim 16, wherein said Website further comprises promotional material related to the sponsoring organisation.

18. The method as in claim 1, wherein the field of endeavour consists of an industry.

19. The method as in claim 18, wherein said industry is selected from a group consisting of the shipping industry, the foods industry, the marketing industry, the fuel industry and the legal services industry or a combination thereof.

20. The method as in claim 1, the method further comprising the steps of:
monitoring an activity of said opt-in stakeholders accessing the service; and
providing a report on said activity to the organisation.

21. The method as in claim 1, wherein said independent information and said dependent information is displayed in an article format.

22. The method as in claim 1, wherein said dependent information comprises at least one advertorial.

23. The method as in claim 1, wherein said independent information comprises CSR information.

24. The method as in claim 1, wherein said dependent information comprises CSR information.

25. A method for providing a service for publishing information, the service sponsored by an organisation in an industry, the published information for distribution to stakeholders in the industry, the method comprising the steps of:
obtaining independent information on at least one topic of relevance to the industry;
obtaining dependent information, said dependent information related to the organisation;
inviting the stakeholders to opt-in for the service;
providing said opt-in stakeholders access to the service;
providing a customized layout in accordance with instructions received from the organisation; and
displaying both said independent information and said dependent information to said opt-in stakeholders in accordance with said layout.

26. A Web based publication system for publishing information, the system sponsored by at least one organisation operating in respective fields of endeavour, the published information for distribution to stakeholders in the at least one organisation, the system comprising:
a database;
a server in communication with said database; and
at least one client in communication with said server;
said database containing independent information on at least one topic of relevance to the respective fields of endeavour and dependent information related to the at least one organisation;
wherein the stakeholders in a particular organisation of the at least one organisation are invited to register on the system; and
wherein said registered stakeholders in said particular organisation have access, using said at least one client, to both said independent information and to said dependent information related to said particular organisation.

27. The system as in claim 26, wherein said independent information and said dependent information is displayed on a publication e-mail pushed to said at least one client from said server, said registered stakeholders having access to said publication e-mail.

28. The system as in claim 26, wherein said independent information and said dependent information is displayed on a publication Website on said server, said registered stakeholders having access to said Website.

29. The system as in claim 28, wherein said registered stakeholders receive periodic publication e-mail pushes from said server announcing a new publication on said Website.

30. The system as in claim 29, wherein said e-mail pushes comprise at least one link to said Website.

31. The system as in claim 29, wherein said e-mail pushes comprise a subset of said independent information and said dependent information.

32. The system as in claim 28, wherein said Website is dynamically configured for said particular organisation to provide registered stakeholders in said particular organisation access to a customized Website comprising said independent information and said dependent information related to said particular organisation.

33. The system as in claim 32, wherein said customized Website comprises a customized layout for displaying said independent information and said dependent information, said layout provided in accordance with instructions received from said particular organisation, said independent information and said dependent information being displayed according to said layout.

34. The system as in claim 28, wherein said Website comprises a registration Webpage, said registration Webpage allowing stakeholders to register on the system.

35. The system as in claim 28, further comprising a means for monitoring an activity of said registered stakeholders in said particular organisation on said Website and reporting said activity to said particular organisation.

36. A server system, the server system providing a publication service for publishing information, the service sponsored by at least one organisation operating in respective fields of endeavour, the published information for distribution to registered stakeholders in the at least one organisation, the registered stakeholders accessing the service using clients in communication with the server system, the server system comprising:
a database; and
a server in communication with said database and configured for communication with the clients;
said database comprising independent information on at least one topic of relevance to the respective fields of endeavour, dependent information related to the at least one organisation and information on the registered stakeholders;
wherein the registered stakeholders in a particular organisation of the at least one organisation have access to both said independent information and to said dependent information related to said particular organisation.

37. The server system as in claim 36, wherein said independent information and said dependent information is displayed on a publication e-mail pushed to said clients from said server, said registered stakeholders having access to said publication e-mail.

38. The server system as in claim 36, wherein said independent information and said dependent information are displayed on a publication Website on said server, said registered stakeholders having access to said Website.

39. The server system as in claim 38, wherein said registered stakeholders receive periodic publication e-mail pushes from said server announcing a new publication on said Website.

40. The server system as in claim 39, wherein said e-mail pushes comprise at least one link to said Website.

41. The server system as in claim 39, wherein said e-mail pushes comprise a subset of said independent information and said dependent information.

42. The server system as in claim 39, wherein said Website is dynamically configured for said particular organisation to provide registered stakeholders in said particular organisation access to a customized Website comprising said independent information and said dependent information related to said particular organisation.

43. The server system as in claim 42, wherein said customized Website comprises a customized layout for displaying said independent information and said dependent information, said layout provided in accordance with instructions received from said particular organisation, said independent information and said dependent information being displayed according to said layout.

44. The server system as in claim 38, wherein said Website comprises a registration Webpage, said registration Webpage allowing new stakeholders to register on the server system.

45. The server system as in claim 38, further comprising monitoring a means for monitoring an activity of said registered stakeholders in said particular organisation on said Website and reporting on said activity to said particular organisation.

46. A publication provided by an independent publication service provider, the publication sponsored by an organisation operating in a field of endeavour for distribution to stakeholders in the organisation who opt-in for receiving the publication, the publication comprising:
independent information on at least one topic of relevance to the field of endeavour;
dependent information related to the organisation; and
a customized layout designed in accordance with instruction received from the organisation;
said independent information and said dependent information being displayed in the publication in accordance with said layout.

47. The publication as in claim 46, wherein the publication is distributed by e-mail.

48. The publication as in claim 46, wherein the publication is displayed on a Website, the opt-in stakeholders having access to said Website.

49. The publication as in claim 48, wherein the opt-in stakeholders are periodically invited to said Website by a publication e-mail push.

50. The publication as in claim 49, wherein said e-mail push comprises at least one link to said Website.
